(19) United States
(12) Patent Application Publication
(10) Pub. No.: US 2015/0135905 A1
(43) Pub. Date: May 21, 2015

(54) Rotary cutting tool with helically running cutting edges and method of manufacturing such a tool

(71) Applicant: Jakob Lach GmbH & Co. KG, Hanau (DE)

(72) Inventor: Eugen MAURER, Ober-Morlen (DE)

(21) Appl. No.: 14/508,189

(22) Filed: Oct. 7, 2014

(30) Foreign Application Priority Data
Oct. 7, 2013 (DE) 102013111090.8
Apr. 3, 2014 (DE) 102014104781.8

(51) Int. Cl. B23B 27/20; B23C 5/10; B23D 77/02; B23B 51/02

(52) U.S. Cl. CPC B23B 27/20; B23B 51/02; B23C 5/1081; B23D 77/02; B23B 2226/315; B23C 2226/315; B23D 2277/245
USPC 76/115; 407/56; 408/230

(57) ABSTRACT

The invention relates to a rotary cutting tool (10), in particular a milling tool, boring tool or a reamer, with a metallic base tool body (12) with at least one preferably helical flute (16, 18), preferably with a pair of flutes, wherein a cutting element (24, 26) of an ultra-hard cutting material such as polycrystalline diamond (PKD) or polycrystalline, cubic boron nitride (PCBN) for forming a helically running cutting edge (28) is associated with the at least one flute and is connected such as soldered to the base tool body (12; 42; 70; 94). In order to increase the service life and simplify the manufacture, it is provided that the cutting element (24, 26) is constructed as a one-part diamond body (24, 26) or from several diamond segments in the form of a section of a solid body that is/are received in a receptacle (20, 22) constructed along the flute (16, 18), wherein the helically curved cutting edge is constructed in the diamond body or the diamond segments in a material-removing manner.

The invention relates to a rotary cutting tool, in particular a milling tool, boring tool or a reamer, with a metallic base tool body with at least one preferably helical flute, preferably with a pair of flutes, wherein a cutting element or cutting insert of an ultra-hard cutting material such as polycrystalline diamond (PKD; Engl. PCD) or polycrystalline, cubic boron nitride (PKBN; Engl. PCBN) for forming a helically running cutting edge is associated with the at least one flute and is connected such as soldered to the base tool body, and relates to a method of manufacturing a rotary cutting tool.

A rotary cutting tool and a method of manufacturing such a tool is described in DE 689 11 468 T2. The known rotary cutting tool comprises a metallic base tool body helically provided with flutes and comprises a polycrystalline diamond film that covers at least a part of a cutting surface of the base metallic tool body provided with flutes. The polycrystalline diamond film has a thickness in the range of 50 to 300 μm. According to this technology the polycrystalline diamond film is manufactured by being vaporized onto a bolt of molybdenum or something similar. The molybdenum substrate is introduced into hot aqua regia and dissolved in order to allow only the helical diamond band to stand. This diamond film is then hard-soldered onto the cutting surface of the flute of the cutting tool with a hard-solder agent. Subsequently, the flank surface is polished in order to form a sharp cutting edge.

The method for manufacturing the helical diamond film is rather expensive. Also, the service life of the rotary cutting tool is reduced since the diamond film is very thin.

DE 691 04 363 T2 relates to a rotary cutting tool with cutting edges of hard material extending helically along its length and comprising a rotary cutting tool blank with at least one pair of helical flutes in the side walls of the blank and with a hard material inside the flutes. The hard material is selected from a group consisting of polycrystalline diamond and polycrystalline, cubic boron nitride. The hard material has a cutting edge formed along a front edge, wherein the polycrystalline, hard material is formed in situ in the flutes. The manufacturing method is expensive and the longitudinal extension of the helical cutting edges is limited to 10 mm to 12 mm.

Starting from the above, the present invention has the basic problem of further developing a rotary cutting tool of the initially cited type and a method for manufacturing such a tool in such a manner that the service life is increased and the manufacture is simplified.

The problem is solved in accordance with the invention, among other things, in that the cutting element is constructed as a one-part diamond body in the form of a section of a solid body or of a similar body or that the cutting element is constructed of several diamond segments of a section of a solid body or of similar ones, that the cutting element is received in a receptacle constructed along the flute, wherein the helically curved cutting edge is constructed in the diamond body or the diamond segments in a material-removing manner

The cutting insert or the cutting element is preferably constructed as at least one diamond segment or diamond body that rests with at least one straight surface against a stop constructed along the flute, wherein the helically curved cutting edge is introduced in a material-removing manner in a surface opposite and/or bordering the straight surface.

The at least one diamond segment of the diamond body is preferably constructed as a section of a solid body in the form of a plate-shaped or disk-shaped solid PKD blank or a solid PKBN blank, wherein the blanks have a layer thickness D in the range of 0.3 mm≦D≦5 mm, preferably 1 mm≦D≦4 mm, especially preferably D=2 mm.

The diamond body forming the cutting element can also be disposed as a solid PKD or solid PKBN on a base body such as a hard metallic carrier or between two base bodies such as hard metallic carriers as a sandwich PKD blank or sandwich PKBN blank, wherein the cutting elements are cut out of the blank.

The at least one diamond body can also be constructed as a CVD thin layer, CVD thick layer or mono-diamond onto the base tool body.

Another preferred embodiment is distinguished in that the diamond body or the diamond segment is constructed as a preferably rod-shaped, annular segment. The annular segment is cut out of the plate-shaped or disk-shaped solid PKD blank, solid PCBN blank, sandwich PKD blank or sandwich PCBN blank and preferably has a height H in the range of 0.1 mm≦H≦10 mm, preferably 2 mm≦H≦4 mm, and a length L1 in the range of 1 mm≦L1≦120 mm, preferably L1=30 mm.

The stop is preferably part of a receptacle constructed in an L-shape or U-shape and miming in a straight line or helically that is introduced such as ground into the base tool body in a material-removing manner.

In an embodiment in which the L-shaped or U-shaped receptacle runs straight at an angle α relative to the longitudinal axis of the tool the diamond body can be constructed as a planar annular segment, wherein a curved inner edge rests on a lower shank or section of the L-shaped or U-shaped receptacle and a curved outer edge forms a radial outer surface.

Furthermore, it is provided that the spiral angle α is in a range of 1°≦α≦30 and that the spiral angle α is in a range of 5°≦α≦50° in an embodiment of the several individual diamond segments disposed successively in the longitudinal direction.

Another preferred embodiment is distinguished in that the cutting insert or the cutting element is constructed from a plurality of preferably plate-shaped diamond segments, wherein the plurality of diamond segments is disposed along a helically running stop or a helically running receptacle and is connected such as soldered to the base tool body. In this embodiment the helically running cutting edge is constructed by a plurality of cutting edge segments of the individual diamond segments.

The helical cutting edge is preferably constructed from a plurality of cutting edge sections of the individual diamond segments. A cutting surface and also a free surface are preferably formed that are helically curved.

Furthermore, the cutting element has a round bevel, wherein the round bevel has a width B that is constant, smaller or becomes larger over the longitudinal extension of the cutting element.

Furthermore, the problem is solved by a method for manufacturing a rotary cutting tool with a cutting element comprising an ultra-hard cutting material such as polycrystalline diamond (PKD) or polycrystalline, cubic boron nitride (PKBN; PCBN) that preferably has the following steps:
Manufacture of a metallic base tool body with at least one or a pair of preferably helically running flutes, each with a receptacle for a cutting insert or preferably with at least one receptacle for the cutting element along a spiral angle α,
Manufacture of a cutting insert or cutting element,
Connecting the cutting insert or cutting element to the base tool body, preferably in the at least one receptacle of the base tool body,

wherein the cutting insert is preferably constructed as a diamond segment with an oversize in the radial and/or circumferential direction and is connected to the base tool body, and wherein a cutting edge running helically or in a spiral in a radial and/or circumferential direction is constructed by removing material from the diamond segment connected to the base tool body.

Alternatively, one-part diamond bodies in the form of a section of a solid body or multiple diamond segments each in the form of a section of a solid body can be used as cutting element and fastened in the receptacle in such a manner that the cutting element has an oversize opposite a theoretical size in the radial and/or circumferential direction, and that a helically running cutting edge is formed by removing material in the radial and/or circumferential direction from the cutting element connected to the base tool body.

It is especially preferred that the cutting element is constructed as one-part diamond body or of several diamond segments each in the form of a section of a solid body and is fastened in the receptacle in such a manner that the cutting element has an oversize in the radial and/or circumferential direction opposite a theoretical size and that a helically running cutting edge is formed by material removal in the radial and/or circumferential direction from the cutting element connected to the base tool body.

The cutting insert or the cutting element is preferably constructed as at least one diamond segment or diamond body that rests with at least one straight surface against a stop constructed along the flute, wherein the helically curved cutting edge is introduced in a material-removing manner in a surface comprising an oversize opposite or bordering on the straight surface in the radial and/or circumferential direction.

A plate-shaped or disk-shaped solid PKD blank or solid PCBN blank can be used as the solid body from which the one-part diamond bodies or the diamond segments are cut out and/or a blank such as a sandwich PKD or sandwich PCBN is used as the solid body, wherein the diamond body is disposed as a solid PKD or solid PKBN on a base body such as a hard metal carrier or between two base bodies such as hard metal carriers, and wherein the cutting elements are cut out of the blank.

The at least one diamond segment or the diamond body is preferably constructed from a plate-shaped or disk-shaped solid PKD blank, solid PCBN blank, wherein the blanks have a layer thickness D in the range of 0.3 mm≦D≦5 mm, preferably 1 mm<D≦4 mm, especially preferably D=2 mm. The diamond body can also be a component of a plate-shaped or disk-shaped sandwich PKD blank or a sandwich PKBN blank, wherein the diamond body is disposed as a solid PKD or solid PKBN on a base body such as a hard metal carrier or between the base bodies such as hard metal carriers. The at least one diamond body can also be applied as a CVD thin layer, CVD thick layer or mono-diamond onto the base tool body.

If the diamond body or the diamond segments is/are manufactured from a solid PKD blank or solid PKBN blank, the diamond body or the diamond segments are preferably connected by vacuum soldering to the base tool body. When constructed as a sandwich PKD blank or sandwich PCBN blank, the metallic bottom of the sandwich structure can preferably be hard-soldered or laser-welded.

The diamond segments or the diamond body is/are preferably cut by a wire erosion method or laser method from a plate-shaped or disk-shaped solid PKD blank or solid PCBN blank, sandwich PKD blank or sandwich PCBN blank.

Even the material removal for manufacturing the spiral cutting edge and/or cutting surface takes place by an eroding method, wherein the diamond segments of the diamond body connected to the base tool body is/are conducted past the rotating, disk -shaped carbon electrode in a spiral movement preferably positioned at an angle α in accordance with the spiral to the longitudinal axis of the tool.

Alternatively, the material removal can take place by laser methods.

In the removal of material the width of a round bevel, i.e., the circumferential extent of the diamond body or of the circumferential segments in the longitudinal direction of the spiral cutting edge can be, for example, approximately 2 mm to approximately 0.8 mm. The width B of the round bevel can be constant or increase or decrease in the longitudinal direction.

The spiral angle α can be, in an embodiment with an annular, segmental diamond body, in the range of 1°<α<30° and in an embodiment with individual diamond segments successively disposed in the longitudinal direction in a range of 5°<α<50°.

Other details, advantages and features of the invention result not only from the claims, the features to be gathered from them by themselves and/or in combination but also from the following description of preferred exemplary embodiments to be gathered from the drawings.

In the drawings:

FIG. 1 shows a first lateral view of a first embodiment of the rotary cutting tool in 0° position,

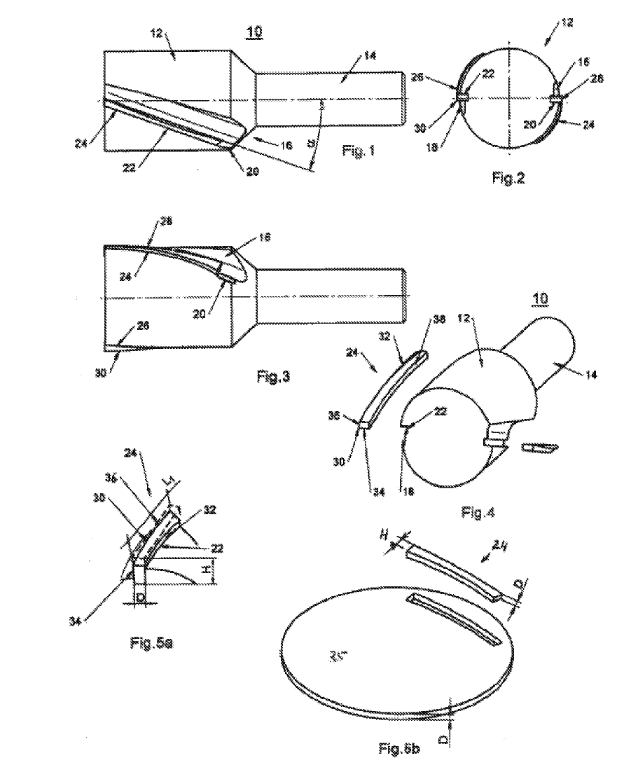

FIG. 2 shows a top view of the rotary cutting tool according to FIG. 1,

FIG. 3 shows a second lateral view of the rotary cutting tool in 90° position,

FIG. 4 shows a perspective exploded view of the rotary cutting tool,

FIG. 5a shows a perspective detailed view of a diamond segment,

FIG. 5b shows a perspective view of a PKD blank with a cut-out cutting element,

FIG. 6 shows a first lateral view of a second embodiment of a rotary cutting tool in the shape of a reamer with cutting edges extending helically along its length in 90° position,

FIG. 7 shows a top view onto the rotary cutting tool according to FIG. 6,

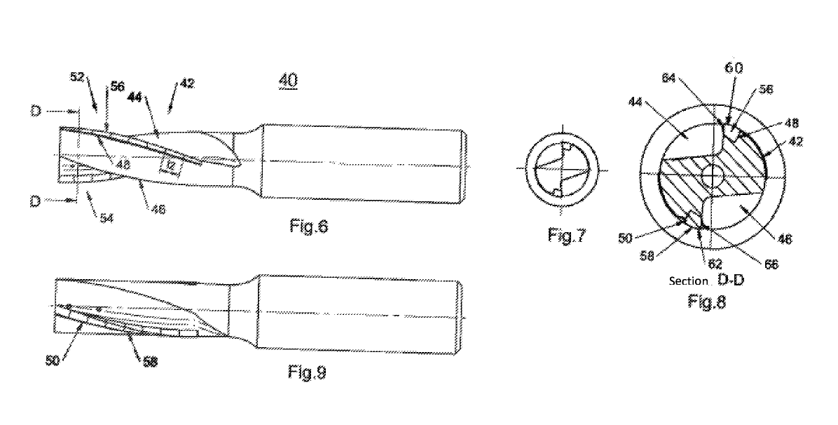

FIG. 8 shows a sectional view of the rotary cutting tool according to FIG. 6 along the section D-D, and

FIG. 9 shows a second lateral view of the rotary cutting tool according to FIG. 5 in 0° position,

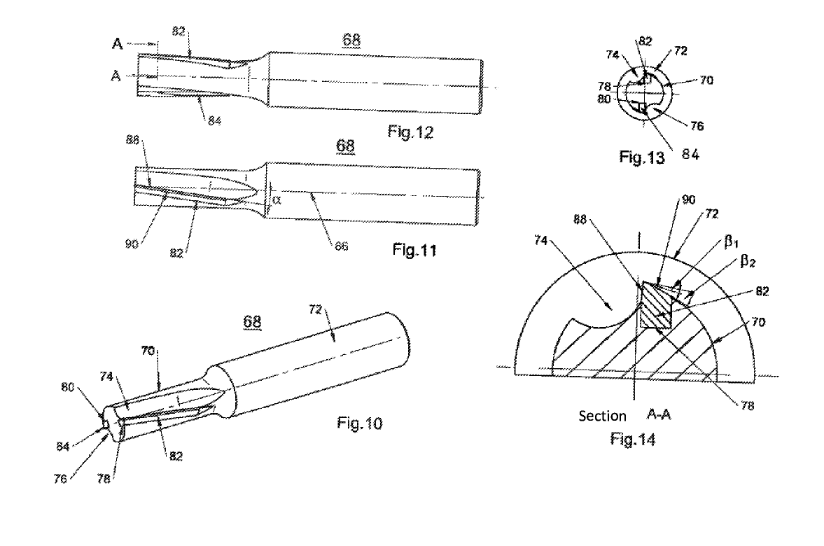

FIG. 10 shows a perspective view of a third embodiment of a rotary cutting tool,

FIG. 11 shows a first lateral view of the rotary cutting tool according to FIG. 10 in 0° position,

FIG. 12 shows a second lateral view of the rotary cutting tool according to FIG. 10 in 90° position,

FIG. 13 shows a top view of the rotary cutting tool according to FIG. 10,

FIG. 14 shows a sectional view of the rotary cutting tool according to FIG. 12 along the section A-A,

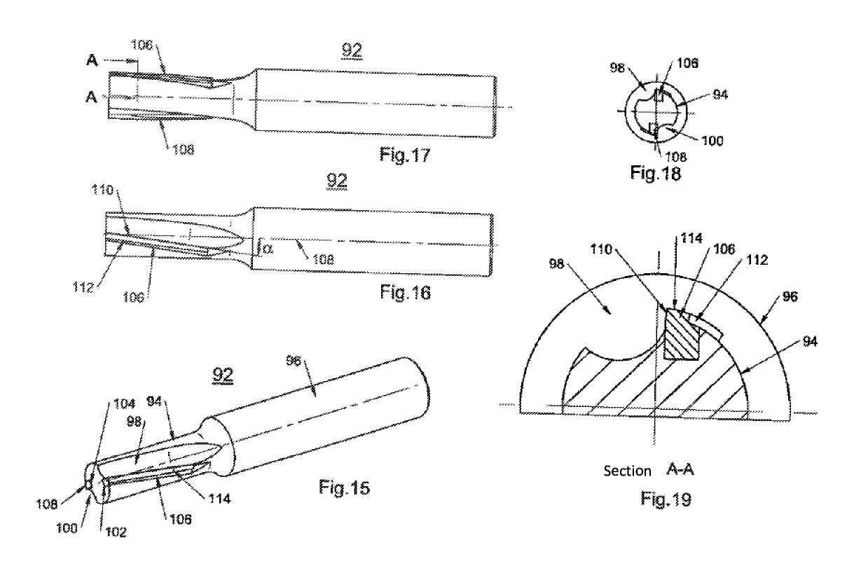

FIG. 15 shows a perspective view of a fourth embodiment of a rotary cutting tool,

FIG. 16 shows a first lateral view of the rotary cutting tool according to FIG. 15 in 0° position,

FIG. 17 shows a second lateral view of the rotary cutting tool according to FIG. 15 in 90° position,

FIG. 18 shows a top view onto the rotary cutting tool according to FIG. 15, and

FIG. 19 shows a sectional view of the rotary cutting tool according to FIG. 17 along the section A-A.

FIG. 1 shows a lateral view of a first embodiment of a rotary cutting tool 10 in the form of a reamer with a metallic base tool body 12 from which a shaft 14 emanates. The base tool body 12 is connected in one piece to the shaft 14.

The base tool body 12 comprises a pair of helical flutes 16, 18 with an L-shaped or U-shaped receptacle 20, 22 along whose course a one-part cutting element, designated in the following as cutting insert 24, 26, consisting of ultra-hard cutting material such as polycrystalline diamond (PKD) or polycrystalline, cubic boron nitride (PKBN) in which a helically curved cutting edge 28, 30 is introduced by material removal.

The diamond body 24 in the form of the circular arc segment is shown in a perspective view in FIG. 4 and has straight lateral surfaces 32, 34, wherein the straight lateral surface 32 forms a free surface and is received in the straight, U-shaped receptacle 22, and wherein the straight lateral surface 34 (cutting surface) on the flute side as a free surface and a radial outer surface (36) round bevel) have an oversize, as is shown in FIG. 5a. An arched inner edge 38 is received in the receptacle 22, that is ground with a spiral angle α relative to the longitudinal axis into the base tool body 12.

The helically curved cutting edge 30 is introduced in a material-removing manner, preferably ground by an eroding method or laser method into the straight lateral surface (34 (cutting surface) on the flute side and into the radial outer surface (36 (round bevel) of the diamond body 24. The flute-side lateral surface 34 has a constant cutting angle over the entire length.

According to the present invention the cutting insert 24, 26 is constructed as a plate-shaped, one-part diamond body in the form of a section of a solid body 35 and clamping a plane, which body is shown in FIG. 5b. In the exemplary example shown the diamond body 24, 26 is constructed as a segment of a circular arc cut out of a plate -shaped solid PKD blank as solid body 35. The diamond body can also be manufactured from a solid PKBN blank or be a component of a sandwich PKD blank or sandwich PCBN blank, wherein the diamond body is disposed as a solid PKD or solid PKBN on a base body such as a hard metallic carrier or between two base bodies such as hard metallic carriers. The cutting insert comprising the diamond body is then cut out of the sandwich PKD or sandwich PKBN.

A method for manufacturing the rotary cutting tool in accordance with the invention is distinguished in that the cutting insert 24, 26 is cut out of the plate -shaped blank 35 with a radial and circumferential oversize opposite a theoretical size as a plate -shaped diamond body clamping a plane, and is connected to the tool body. The helical cutting edge is then introduced into the flute-side lateral surface 34 and radial outer surface 36 of the diamond body in a material-removing manner preferably by an electroerosive eroding method or laser method by material removal in the diamond body connected to the base tool body. The base tool body executing a spiral movement is moved here with a cutting edge along a rotating electrode such as a carbon electrode aligned at an angle to the longitudinal axis of the base tool body.

The diamond bodies 24, 26 of polycrystalline material such as solid PKD, solid PKBN can be cut out of the plate or disk 35 by a wire eroding method. The diamond bodies can have a layer thickness D in the range of 0.3 mm to 4 mm, preferably D=2 mm. Furthermore, the diamond body can have a length L in the range of 5 mm≦L≦50 mm.

The angle α can have angles in the range of 5°≦α≦30°, preferably α=20° in a one-piece or one-part embodiment of the diamond body. The blanks of the diamond bodies can have a radial extension or height H in the range of 2mm ≦H≦4 mm.

The FIGS. 6 to 9 show an alternative embodiment of a rotary cutting tool 40 for milling or abrading. The tool has spiral flutes 44, 46 in a base tool body 42, wherein a cutting insert 52, 54 in the form of individual segments 56, 58 of polycrystalline diamond such as solid PKD or solid PKBN disposed along the receptacle 48, 50 is formed along the receptacle 48, 50 of the spiral flute 44, 46, which receptacle forms a stop. The segments 56, 58 are constructed in the shape of plates and can be manufactured from solid PKD/-PKBN or sandwich PKD/PKBN. The individual segments 56, 58, that have a longitudinal extension L2 in the range of 5 mm≦L2≦15 mm, are connected to the base tool holder 42 by vacuum soldering or hard soldering.

The diamond segments 56, 58 with a radial oversize relative to a theoretical size are subsequently processed by an eroding method or laser method, wherein a spiral surface 60, 62 (round bevel) is formed with a spiral cutting edge 64, 66.

In this embodiment the radial outer surface 60 (round bevel) and also the cutting surface 64, 66 is worked with a preferably positive cutting surface angle by the eroding method or laser method, wherein the round bevel in the form of the radial outer surface 60, 62 and also a cutting breast or cutting surface in the form of the cutting surface 64, 66 are worked. During this time the surfaces 60, 62 are converted into a circumferential surface of the base tool body 42 and the cutting surface is 64, 66 into a surface clamped by the flutes 44, 46, preferably by an electroerosive eroding method or laser method, preferably by an electroerosive eroding or laser method.

The spiral cutting jacket edge or cutting edge is preferably introduced by an eroding method with removal of material. Alternatively, a laser method can also be used.

FIG. 10 shows a perspective view of a third embodiment of a rotary cutting tool 68 with a metallic base tool body 70 with shaft 72. The base tool body 70 comprises a pair of helical flutes 74, 76 with a U-shaped receptacle 78, 80 along whose course a cutting insert 82, 84 of ultra-hard cutting material such as polycrystalline diamond (PKD) or polycrystalline, cubic boron nitride (PKBN) is disposed.

FIGS. 11 to 13 show views of the rotary cutting tool 68 from which it can be gathered that the cutting insert 82 encloses a spiral angle α with a longitudinal axis 86 of the rotary cutting tool 68. The spiral angle α is in the range of 1°≦α≦30°, preferably α=5°

FIG. 14 shows a sectional view along the section A-A according to FIG. 12 of the base tool body 70 with flute 74 and cutting insert 82, that is fastened such as by soldering in the receptacle 78. FIG. 14 shows the cutting insert 82 in the worked state with a spiral cutting surface 88 and a free surface 90 that has a free angle β₁ in a first section and a free angle α₂ in a second section. The cutting surface 88 and the free surface 90 were worked by spark eroding methods. The cutting surface 88 and also the free surface 90 have a spiral course relative to the longitudinal axis 86 of the rotary cutting tool 68.

FIG. 15 shows a perspective view of a fourth embodiment of a rotary cutting tool 92 with a metallic base tool body 94 and a shaft 96. The base tool body 94 comprises a pair of helical flutes 98, 100 with a U-shaped receptacle 102, 104 along whose course a cutting insert 106, 108 of ultra-hard cutting material such as polycrystalline diamond (PKD) or polycrystalline, cubic boron nitride (PKBN) is arranged such as soldered.

FIGS. 16 to 18 show views of the base tool body 92, whereby the cutting insert 106 encloses an angle α in the range of approximately 5° relative to a longitudinal axis 108 of the rotary cutting tool 92.

According to FIG. 19, that shows a sectional view along the section line A-A according to FIG. 17, a cutting surface 110 of the cutting insert 106 is formed along a spiral line of projecting material of the cutting insert 106, in particular worked out by a material-removing method such as an electroeroding method. A free surface 112 is worked in as eccentric relief opposite the cutting surface 110. A round bevel 114 is formed in an outer surface and is shown in the lateral view according to FIG. 16. In this embodiment a width B of the round bevel 114, 116 tapers in the longitudinal direction of the cutting insert 106.

1. A rotary cutting tool (10; 40; 68; 92), in particular a milling tool, boring tool or a reamer, with a metallic base tool body (12; 42; 70; 94) with at least one preferably helical flute (16, 18; 44, 46; 74, 76; 98, 100), preferably with a pair of flutes, wherein a cutting element (24, 26; 56, 58; 82, 84; 106, 108) of an ultra-hard cutting material such as polycrystalline diamond (PKD; Engl. PCD) or polycrystalline, cubic boron nitride (PKBN; Engl. PCBN) for forming a helically running cutting edge (28, 30; 64, 66; 88; 110) is associated with the at least one flute and is connected such as soldered to the base tool body (12; 42; 70; 94),
characterized in that
the cutting element (24, 26; 56, 58; 82, 84; 106, 108) is constructed as a one-part diamond body (24, 26; 82, 84; 106, 108) in the form of a section of a solid body or of several diamond segments (56, 58) in the shape of a section of a solid body, that the cutting element is received in a receptacle (20, 22; 48, 50; 78, 80; 102, 104) constructed along the flute (16, 18; 44, 46; 74, 76; 98, 100), and that the helically curved cutting edge is constructed in the diamond body or the diamond segments in a material-removing manner

2. The rotary cutting tool according to claim 1,
characterized in that
the solid body is a plate-shaped or disk-shaped blank of solid PKD or solid PKBN, and/or that the solid body is a plate-shaped or disk-shaped sandwich PKD blank or sandwich PKBN blank, wherein a solid PKD or a solid PKBN is disposed between two base bodies such as hard metal carriers, and/or that the solid body is a plate-shaped or disk-shaped blank consisting of a base body such as a hard metal carrier on which the solid PKD or solid PKBN is disposed.

3. The rotary cutting tool according to claim 2,
characterized in that
the solid PKD or the solid PKBN has a layer thickness D in the range of 0.3 mm<D<5 mm, preferably 1 mm<D<4 mm, especially preferably D=2 mm.

4. The rotary cutting tool according to claim 1,
characterized in that
the at least one cutting element (24, 26; 56, 58; 82, 84; 106, 108) is constructed as a CVD thin layer, CVD thick layer or as a mono-diamond on the base tool body (12; 42; 70; 94).

5. The rotary cutting tool according to claim 1,
characterized in that
the one-part diamond body (24, 26; 82, 84; 106, 108) is constructed as a preferably rod-shaped, annular segment that is rectangular in cross section.

6. The rotary cutting tool according to claim 5,
characterized in that
the annular segment (24, 26; 82, 84; 106, 108) is cut out of the plate-shaped or disk-shaped solid PKD blank, solid PCBN blank, sandwich PKD blank or sandwich PCBN blank.

7. The rotary cutting tool according to claim 5,
characterized in that
the annular segment (24, 26; 82, 84; 106, 108) preferably has a height H in the range of 0.1 mm<H<10 mm, preferably 2 mm<H<4 mm, and a length L1 in the range of 1 mm<L1<120 mm, preferably 1 mm<L1<4 mm, 5 mm<L1<50 mm, preferably L1=30 mm.

8. The rotary cutting tool according to claim 1,
characterized in that
the receptacle (20, 22; 78, 80; 102, 104) is constructed to be L-shaped or U-shaped and/or that the receptacle (20, 22; 78, 80; 102, 104) runs in a straight line or helically in a spiral angle α relative to the longitudinal axis of the tool, and that the receptacle (20, 22; 78, 80; 102, 104) is constructed as ground in a material-removing manner in the base tool body (12; 42; 70; 94).

9. The rotary cutting tool according to claim 5,
characterized in that
the annular, segment-shaped diamond body (24, 26; 82, 84; 106, 108) comprises an arched inner wall adapted in its curvature to a section of the L-shaped or U-shaped receptacle (20, 22; 78, 80; 102, 104) and comprises an arched outer edge forming a radial outer surface.

10. The rotary cutting tool according to claim 8,
characterized in that
the spiral angle α is, in the case of the one-part, annular diamond body (24, 26; 82, 84; 106, 108) in a range of 1°<α<30° and that the spiral angle α is in a range of 5°<α<50° in an embodiment with several individual diamond segments (56, 58) successively disposed in the longitudinal direction.

11. The rotary cutting tool according to claim 1,
characterized in that
the receptacle (48, 50) is constructed helically in an embodiment with several individual diamond segments (56, 58) disposed successively in the longitudinal direction, wherein the several individual diamond segments (56, 58) are arranged along the helically running receptacle and are connected such as by soldering to the base tool body.

12. The rotary cutting tool according to claim 1,
characterized in that
the helical cutting edge is formed from a plurality of cutting edge sections of the individual diamond segments.

13. The rotary cutting tool according to claim 1,
characterized in that
the cutting surface as well as a free surface of the cutting element (24, 26; 56, 58; 82, 84; 106, 108) are constructed in a helically curved manner

14. The rotary cutting tool according to claim 1,
characterized in that
the cutting element (24, 26; 56, 58; 82, 84; 106, 108) has a round bevel, wherein the round bevel has a width B that is constant, smaller or becomes larger over the longitudinal extension of the cutting element.

15. A method for manufacturing a rotary cutting tool with a cutting element comprising an ultra-hard cutting material such as polycrystalline diamond (PKD; Engl. PCD) or polycrystalline, cubic boron nitride (PKBN; Engl. PCBN) that comprises the following method steps:
a) Manufacture of a metallic base tool body with at least one receptacle for the cutting insert along a spiral angle α,
b) Manufacture of the cutting element,
c) Fastening such as soldering the cutting element in the at least one receptacle of the base tool body,
characterized in that
one-part diamond bodies in the form of a section of a solid body for several diamond segments in the form of a section of a solid body are used as cutting element and are fastened in the receptacle in such a manner that the cutting element comprises an oversize in the radial and/or circumferential direction opposite a theoretical size, and that a helically running cutting edge is formed by the removal of material in the radial and/or circumferential direction of the cutting edge connected to the base tool body.

16. The method according to claim 15,
characterized in that
the cutting edge is constructed in a material-removing manner in a cutting surface, comprising an oversize in the radial or circumferential direction, and/or in a free surface of the cutting element.

17. The method according to claim 15,
characterized in that
a plate-shaped or disk-shaped solid PKD blank or solid PCBN blank is used as solid body from which the one-part diamond body or the diamond segments are cut out, and/or that a blank such as a sandwich PKD or sandwich PCBN is used as solid body, wherein the diamond body is disposed as a solid PKD or solid PKBN on a base body such as a hard metal carrier or between two base bodies such as hard metal carriers, and wherein the cutting elements are cut out of the blank.

18. The method according to claim 15,
characterized in that
the removal of material for manufacturing the spiral cutting edge takes place at a constant cutting angle.

19. The method according to claim 17,
characterized in that
the diamond bodies or the diamond segments manufactured from solid PKD or solid PKBN are connected preferably by vacuum soldering to the base tool body.

20. The method according to claim 17,
characterized in that
the cutting elements manufactured from the sandwich PKD blank or the sandwich PKBN blank are connected by a metallic bottom of the sandwich structure to the base tool body preferably by hard soldering or laser welding.

21. The method according to claim 15,
characterized in that
the diamond body or the diamond segments is/are cut out by a wire erosion method or laser method from a plate-shaped or disk-shaped solid PKD blank or solid PCBN blank, sandwich PKD blank or sandwich PCBN blank.

22. The method according to claim 15,
characterized in that
the material removal for manufacturing the spiral cutting edge takes place by an eroding method, wherein the diamond body or the diamond bodies connected to the tool body or the connected diamond segments is/are conducted past the rotating, preferably disk shaped electrode such as a carbon electrode or copper electrode in a spiral movement preferably positioned at a spiral angle α in accordance with the spiral to the longitudinal axis of the tool.

23. The method according to claim 15,
characterized in that
the material removal for manufacturing the spiral cutting edge takes place at a constant cutting angle by a laser method.

24. The method according to claim 15,
characterized in that
during the removal of material a width B of a round bevel of the diamond body or of the diamond segments tapers in the longitudinal direction of the spiral cutting edge from for example 2 mm to 0.8 mm.

25. The method according to claim 15,
characterized in that
the receptacle for the one-part annular diamond body (24, 26; 82, 84; 106, 108) is constructed with a spiral angle α in a range of 1°<α<30°, and that the receptacle for the several individual diamond segments (56, 58) successively disposed in the longitudinal direction is constructed with a spiral angle α in a range of 5°<α<50°.
